(19) United States
(12) Patent Application Publication
(10) Pub. No.: US 2011/0225147 A1
(43) Pub. Date: Sep. 15, 2011

(54) APPARATUS AND METHOD FOR PROVIDING TAG INFORMATION OF MULTIMEDIA DATA IN MOBILE TERMINAL

(75) Inventors: Taek-Su SHIN, Seoul (KR); Dong-Wook LEE, Hwaseong-si (KR); Jong-Man PARK, Suwon-si (KR)

(73) Assignee: SAMSUNG ELECTRONICS CO. LTD., Suwon-si (KR)

(21) Appl. No.: 13/046,914

(22) Filed: Mar. 14, 2011

(30) Foreign Application Priority Data
Mar. 15, 2010 (KR) 10-2010-0022785

(51) Int. Cl. G06F 17/30

(52) U.S. Cl. 707/722; 707/756; 707/E17.014

(57) ABSTRACT

An apparatus and a method for reproducing a multimedia in a mobile terminal are provided. More particularly, an apparatus and a method for converting meta information of multimedia data reproduced by a mobile terminal into audio data information to reproduce the multimedia data and simultaneously reproducing the meta information are provided. The apparatus includes a meta information analyzer, an audio data generator, and a meta information provider. The meta information analyzer obtains meta information of multimedia data to be reproduced. The audio data generator converts meta information obtained by the meta information analyzer into an audio data format. The meta information provider reproduces the meta information converted into the audio format by the audio data generator and multimedia data.

### PRIORITY

This application claims the benefit under 35 U.S.C. §119(a) of a Korean patent application filed in the Korean Intellectual Property Office on Mar. 15, 2010 and assigned Serial No. 10-2010-0022785, the entire disclosure of which is hereby incorporated by reference.

### BACKGROUND OF THE INVENTION

1. Field of the Invention

The present invention relates to an apparatus and a method for reproducing multimedia in a mobile terminal. More particularly, the present invention relates to an apparatus and a method for converting meta information of multimedia data reproduced by a mobile terminal into audio data information to reproduce the multimedia data and for simultaneously reproducing the meta information.

2. Description of the Related Art

Mobile terminals have become necessities to modern people and are widely used regardless of age or sex. Because of their popularity, service providers and terminal manufacturers competitively develop products (or services) for differentiation from other companies.

For example, the mobile terminal has developed into a multimedia device capable of providing various services such as a phonebook, games, a Short Message Service (SMS), an Electronic (E)-mail, a voice call, a digital camera, a wireless Internet service, and other similar products and services.

To support the trend of providing multimedia services, a mobile terminal that can reproduce a music file has been developed and brought to the market. That is, a mobile terminal that can reproduce a music file is designed to allow a user to listen to music using only the mobile terminal without a separate Motion Picture Expert Group (MPEG)-1 or MPEG-2 Audio Layer-3 (MP3) player or portable cassette player. Due to its convenience, the mobile terminal that can reproduce a music file is widely used by many people.

An MP3 file, which is a digital audio file format that is widely used, adds additional information called an ID3 tag to an encoded audio binary, and provides the additional information to a user when a mobile terminal reproduces a relevant file.

The additional information of the ID3 tag may be a song title, the name of a singer, an album thumbnail image, associated lyrics, etc. Furthermore, the information included in the ID3 tag is increasing.

However, the additional information of the ID3 tag is provided to a user as visual information. Therefore, if the mobile terminal does not have a display module or a user is not viewing the mobile terminal, the information cannot be provided.

For example, in the case where a user of the mobile terminal puts the mobile terminal into his bag and reproduces multimedia data using a Bluetooth headset, the user cannot view information of the ID3 tag that is being displayed. Accordingly, to obtain information of the data that is being displayed, the user has an inconvenience of having to take out and view the mobile terminal that is in the bag.

Therefore, to address the above problem, an apparatus and a method for providing tag information corresponding to data that is being reproduced in a mobile terminal as audio information are required.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for providing tag information of multimedia data that is being reproduced in a mobile terminal as audio information.

Another aspect of the present invention is to provide an apparatus and a method for web-searching for data related to tag information of multimedia data that is being reproduced in a mobile terminal.

Still another aspect of the present invention is to provide an apparatus and a method for reproducing tag information corresponding to multimedia data when a mobile terminal reproduces the multimedia data.

In accordance with an aspect of the present invention, an apparatus for providing tag information of a multimedia file in a mobile terminal is provided. The apparatus includes a meta information analyzer for obtaining meta information of multimedia data to be reproduced, an audio data generator for converting the meta information obtained by the meta information analyzer into an audio data format, and a meta information provider for reproducing the meta information converted into the audio format by the audio data generator and the multimedia data.

In accordance with another aspect of the present invention, a method for providing tag information of a multimedia file in a mobile terminal is provided. The method includes obtaining meta information of multimedia data to be reproduced, converting the obtained meta information into an audio data format, and reproducing the meta information converted into the audio format and the multimedia data.

In accordance with still another aspect of the present invention, a tag information provider for providing tag information of a multimedia file is provided. The tag information provider includes a meta information analyzer for obtaining meta information of multimedia data to be reproduced, a web search unit for performing an Internet search using the meta information obtained by the meta information analyzer as a keyword, and an audio data generator for converting the meta information obtained by the meta information analyzer and a search result obtained by the web search unit into an audio data format.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a mobile terminal for providing tag information of a multimedia file according to an exemplary embodiment of the present invention;

FIG. 2 is a flowchart illustrating a process for providing tag information of a multimedia file in a mobile terminal according to an exemplary embodiment of the present invention;

FIG. 3A is a view illustrating multimedia data reproduced in a mobile terminal according to an exemplary embodiment of the present invention;

FIG. 3B is a view illustrating a process for providing meta information of multimedia data in a mobile terminal according to an exemplary embodiment of the present invention; and

FIG. 3C is a view illustrating a process for reproducing multimedia data in a mobile terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide an apparatus and a method for converting meta information of multimedia data reproduced by a mobile terminal into audio data information to reproduce the multimedia data and for simultaneously reproducing the meta information. In the following description, the multimedia data denotes multimedia data including additional information and includes digital audio data such as way, ogg, mpc, flac, aiff, raw, au, midi, gsm, dct, vox, and other similar audio data, and image data including meta information. The meta information includes tag information.

In addition, the mobile terminal denotes an audio data reproducer capable of reproducing encoded audio data, and denotes a hardware apparatus such as any mobile terminal including a Motion Picture Expert Group (MPEG)-1 or MPEG-2 Audio Layer 3 (MP3) player, a mobile communication terminal, a personal portable terminal, a portable multimedia reproducer in which a digital audio decoder is mounted, and the like. Also, exemplary embodiments of the present invention may use a reproducing apparatus realized in a software manner.

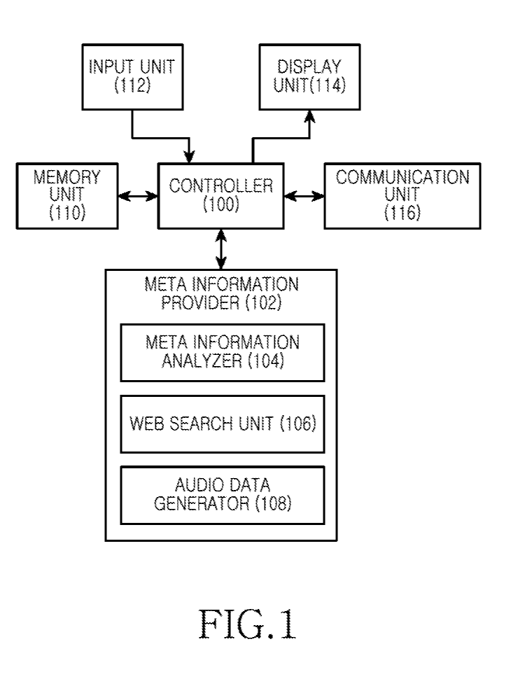

FIGS. 1 through 3C, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

FIG. 1 is a block diagram illustrating a mobile terminal for providing tag information of a multimedia file according to an exemplary embodiment of the present invention.

Referring to FIG. 1, the mobile terminal includes a controller 100, a meta information provider 102, a memory unit 110, an input unit 112, a display unit 114, and a communication unit 116. The meta information provider 102 may include a meta information analyzer 104, a web search unit 106, and an audio data generator 108. However, the mobile terminal may include additional units that are not illustrated here merely for sake of clarity. Similarly, the functionality of two or more of the above noted units may be integrated into a single component.

The controller 100 of the mobile terminal controls an overall operation of the mobile terminal. For example, the controller 100 performs processes and controls for voice communication and data communication. In addition to the general functions, the controller 100 processes to provide tag information of multimedia data reproduced as visual information in the form of audio information.

That is, when reproducing multimedia data, the controller 100 obtains tag information of the multimedia data to be reproduced, and converts the obtained tag information into an audio data format to reproduce the same.

The meta information provider 102 obtains tag information corresponding to the multimedia data from the multimedia data corresponding to a reproduction sequence under control of the controller 100, and converts the obtained tag information into audio data.

The meta information analyzer 104 of the meta information provider 102 obtains tag information of the multimedia data under control of the controller 100. At this point, the meta information analyzer 104 may obtain tag information included in an ID3 tag with respect to MP3 data and obtain tag information included in meta information (e.g., exif file information) with respect to image data. When the tag information of the multimedia data does not exist, the meta information analyzer 104 may use a filename of the multimedia data as tag information or use a message (e.g., an untitled file) representing that the tag information does not exist as tag information.

The web search unit 106 obtains additional information for the tag information obtained by the meta information analyzer 104 under control of the meta information provider 102. At this point, the web search unit 106 performs a wireless Internet search using a wireless network such as any of Code Division Multiple Access (CDMA), General Packet Radio Services (GPRS), Wideband CDMA (WCDMA), Wireless Fidelity (WiFi), Worldwide Interoperability for Microwave Access (WiMAX), and Long Term Evolution (LTE), and obtains a result of the search.

The audio data generator 108 converts the tag information obtained by the meta information analyzer 104 and the search result searched by the web search unit 106 into audio data under control of the meta information provider 102.

In addition, the audio data generator 108 may automatically add and input a postposition so that a proper word is connected when converting the tag information and the search result into voice data.

The memory unit 110 of the mobile terminal includes Read Only Memory (ROM), Random Access Memory (RAM), a flash ROM, or other similar storage devices. The ROM stores microcodes of programs for processes and controls of the controller 100 and the meta information provider 102, and various reference data.

The RAM serves as a working memory of the controller 100 and stores temporary data that occurs during execution of various programs. In addition, the flash ROM stores various updatable data for storage such as a phonebook, calling messages, received messages, information of a user's touch input point, and other similar data.

The input unit 112 includes a plurality of function keys such as numerical key buttons of 0 to 9, a menu button, a cancel button, an OK button, a TALK button, an END button, an Internet access button, navigation key buttons, letter input keys, and other similar input keys and buttons The input unit 112 provides key input data (e.g., a screen switch request) corresponding to a key pressed by a user to the controller 100. For example, according to an exemplary embodiment of the present invention, the input unit 112 provides a multimedia data reproduction request to the controller 100 to reproduce multimedia data and tag information.

The display unit 114 displays status information generated during an operation of the mobile terminal, a limited number of letters, a large amount of moving images and still images, etc. The display unit 114 may be one of various display units (e.g., a color Liquid Crystal Display (LCD), an Active Mode Organic Light Emitting Diode (AMOLED) display, and other similar display apparatuses). The display unit 114 may include a touch input device, and when it is applied to a touch input type mobile terminal, it can be used as an input unit.

The communication unit 116 transmits/receives a Radio Frequency (RF) signal of data input/output via an antenna (not illustrated). For example, during transmission, the communication unit 116 channel-codes and spreads data to be transmitted, and performs an RF process on the signal to transmit the signal. During reception, the communication unit 116 converts a received RF signal into a baseband signal, and despreads and channel-decodes the baseband signal to recover data. According to an exemplary embodiment of the present invention, the communication unit 116 has a wireless network access unit for wireless Internet connection to perform a web search process corresponding to the meta information.

The function of the meta information provider 102 may be performed by the controller 100 of the mobile terminal. The separate configuration and illustration of the meta information provider 102 are for exemplary purpose and for ease of description, not for limiting the scope of the present invention. It would be obvious to those skilled in the art that various modifications may be made within the scope of the present invention. For example, all functions of the meta information provider 102 may be processed by the controller 100.

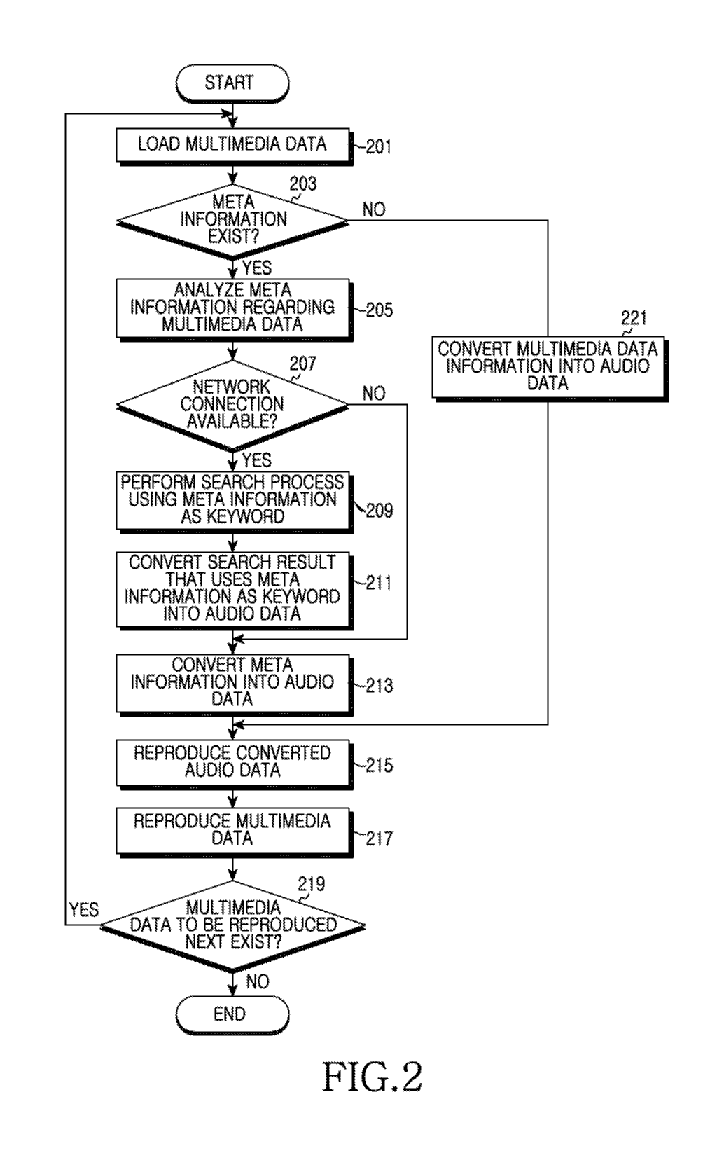

FIG. 2 is a flowchart illustrating a process for providing tag information of a multimedia file in a mobile terminal according to an exemplary embodiment of the present invention.

Referring to FIG. 2, the mobile terminal loads multimedia data to be reproduced among multimedia data stored in a memory in step 201, and determines whether meta information exists in the multimedia data to be reproduced in step 203. Here, the meta information includes information set in an ID3 tag.

When determining in step 203 that the meta information does not exist in the multimedia data, the mobile terminal converts the multimedia data information into audio data in step 221. Here, step 221 is a process for converting the information into audio data using a filename of the multimedia data as tag information or using a message (e.g., an untitled filename) representing that tag information does not exist as tag information.

In contrast, when determining in step 203 that the meta information exists in the multimedia data, the mobile terminal analyzes and obtains meta information of multimedia data in step 205. At this point, the mobile terminal analyzes an ID3 tag added to the encoded audio binary of the multimedia data to obtain the meta information.

The mobile terminal proceeds to step 207 to determine whether a network connection (e.g., a wireless network connection, a wired network connection, etc.) for obtaining additional information for the meta information obtained in step 205 is possible. That is, the mobile terminal may search for additional information (e.g., a chart ranking, recent news, etc.) regarding the multimedia data besides meta information set in the multimedia data and provide the same to a user.

When determining in step 207 that the network connection is not possible, the mobile terminal proceeds to step 213 to convert the meta information obtained in step 205 into audio data.

In contrast, when determining in step 207 that the network connection is possible, the mobile terminal performs a search process using the obtained meta information as a keyword in step 209.

The mobile terminal proceeds to step 211 to convert the search result obtained in step 209 into audio data, and proceeds to step 213 to convert the meta information obtained in step 205 into audio data. At this point, the mobile terminal adds a postposition in itself in order to complete an accurate sentence before converting the information into audio data to provide audio data of natural sentences.

The mobile terminal reproduces the meta information and search result converted into the audio data in step 215, and reproduces multimedia data in step 217. At this point, the mobile terminal provides information regarding reproduced music even when meta information cannot be visually provided by reproducing the meta information and search result converted into the audio data. The reproduction point of the meta information and search result are not important.

That is, the meta information and the search result may be reproduced right before the multimedia data is reproduced, right after the multimedia data is reproduced, or at any point (e.g., at the beginning, the middle, the second half of the reproduction, etc.) of the reproduction of the multimedia data.

The mobile terminal determines whether multimedia data to be reproduced in the next sequence exists in step 219.

When determining in step 219 that the multimedia data to be reproduced in the next sequence exists, the mobile terminal returns to step 201 to perform a process of converting meta information of the multimedia data to be reproduced into audio data and providing the same.

In contrast, when determining in step 219 that the multimedia data to be reproduced in the next sequence does not exist, the mobile terminal ends the present algorithm.

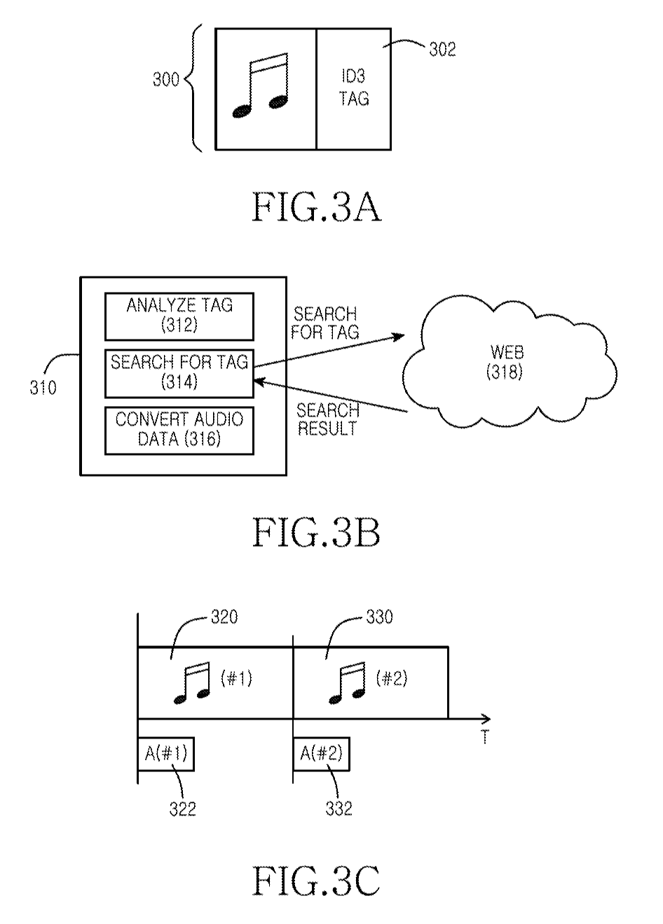

FIGS. 3A to 3C are views illustrating a process for providing meta information of multimedia data as audio data in a mobile terminal according to an exemplary embodiment of the present invention.

FIG. 3A is a view illustrating multimedia data reproduced in a mobile terminal according to an exemplary embodiment of the present invention.

Referring to FIG. 3A, the multimedia data 300 may be a digital audio file such as way, ogg, mpc, flac, aiff, raw, au, and midi, and an ID3 tag 302 is added to an encoded audio binary. The ID3 tag 302 stores additional information of the multimedia data 300 such as information of a genre, an artist, a title, and the like of the multimedia data 300.

In addition, according to an exemplary embodiment of the present invention, in the case where the multimedia data 300 is image data, the tag may include exif file information.

FIG. 3B is a view illustrating a process for providing meta information of multimedia data in a mobile terminal according to an exemplary embodiment of the present invention.

Referring to FIG. 3B, the mobile terminal 310 analyzes (312) a tag of multimedia data to obtain meta information regarding the data before reproducing the multimedia data.

In addition, the mobile terminal 310 performs a process of obtaining additional information of the obtained meta information according to an exemplary embodiment of the present invention.

At this point, the mobile terminal 310 performs a process of searching for (314) the Internet (318) using the obtained meta information as a keyword and obtains a result of the search.

The mobile terminal 310 that has obtained the information converts (316) the information into audio data in order to provide the information in the form of audio data to a user.

FIG. 3C is a view illustrating a process for reproducing multimedia data in a mobile terminal according to an exemplary embodiment of the present invention.

Referring to FIG. 3C, the mobile terminal reproduces (320) multimedia data illustrated in FIG. 3A including meta information.

At this point, according to an exemplary embodiment, the mobile terminal reproduces (322) meta information of the audio data format converted in FIG. 3B and a search result corresponding to the meta information to provide information regarding the data to a user who cannot view visual information.

Generally, the mobile terminal can reproduce the audio data at a point at which the multimedia data starts, but the audio data may be reproduced right before the multimedia data is reproduced, right after the multimedia data is reproduced, or at any point of the reproduction section.

In addition, the mobile terminal may apply a fade-in/fade-out effect to the audio data to provide information naturally without disturbing reproduction of the multimedia data.

After reproducing (320) the multimedia data, the mobile terminal generates and reproduces audio data 332 corresponding to the multimedia data 330 before reproducing the next multimedia data 330.

As described above, exemplary embodiments of the present invention convert meta information of multimedia data reproduced by a mobile terminal into audio data information and allow the mobile terminal to reproduce the meta information simultaneously with the reproduction of the multimedia data, so that a user may receive information regarding the data even without viewing the conventional mobile terminal that provides the information regarding the multimedia data only in the form of visual information.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for providing tag information of a multimedia file in a mobile terminal, the apparatus comprising:
a meta information analyzer for obtaining meta information of multimedia data to be reproduced;
an audio data generator for converting the meta information obtained by the meta information analyzer into an audio data format; and
a meta information provider for reproducing the meta information converted into the audio format by the audio data generator and the multimedia data.

2. The apparatus of claim 1, further comprising a web search unit for performing an Internet search using the obtained meta information as a keyword.

3. The apparatus of claim 2, wherein the audio data generator converts an Internet search result into audio data.

4. The apparatus of claim 1, wherein the meta information provider reproduces the meta information at least one of at a point of reproducing the multimedia data, right before reproduction of the multimedia data, and right after the reproduction of the multimedia data.

5. The apparatus of claim 1, wherein the meta information analyzer analyzes an ID3 tag included in the multimedia data to obtain the meta information of the multimedia data to be reproduced.

6. The apparatus of claim 1, wherein the multimedia data comprises at least one of digital audio data and image data comprising meta information.

7. The apparatus of claim 1, wherein the meta information comprises at least one of a genre, an artist, a title, a filename of the multimedia data, and a message informing that the meta information does not exist.

8. A method for providing tag information of a multimedia file in a mobile terminal, the method comprising:
obtaining meta information of multimedia data to be reproduced;
converting the obtained meta information into an audio data format; and
reproducing the meta information converted into the audio format and the multimedia data.

9. The method of claim 8, further comprising performing an Internet search using the obtained meta information as a keyword.

10. The method of claim 9, further comprising:
converting an Internet search result into an audio data format; and
reproducing the Internet search result converted into the audio format.

11. The method of claim 8, wherein the reproducing of the meta information converted into the audio format and the multimedia data comprises at least one of reproducing the meta information and the multimedia data simultaneously, reproducing the meta information right before the reproduction of the multimedia data, and reproducing the meta information right after the reproduction of the multimedia data.

12. The method of claim 8, wherein the obtaining of the meta information of the multimedia data to be reproduced comprises analyzing an ID3 tag included in the multimedia data.

13. The method of claim 8, wherein the multimedia data comprises at least one of digital audio data and image data comprising meta information.

14. The method of claim 8, wherein the meta information comprises at least one of a genre, an artist, a title, a filename of the multimedia data, and a message informing that the meta information does not exist.

15. A tag information provider for providing tag information of a multimedia file, the tag information provider comprising:
a meta information analyzer for obtaining meta information of multimedia data to be reproduced;
a web search unit for performing an Internet search using the meta information obtained by the meta information analyzer as a keyword; and
an audio data generator for converting the meta information obtained by the meta information analyzer and a search result obtained by the web search unit into an audio data format.

16. The tag information provider of claim 15, wherein the audio data converted by the audio data generator is reproduced at least one of at any point of a reproduction point of the multimedia data, right before the reproduction of the multimedia data, and right after the reproduction of the multimedia data.

17. The tag information provider of claim 15, wherein the multimedia data comprises at least one of digital audio data and image data comprising meta information.

18. The tag information provider of claim 15, wherein the meta information comprises at least one of a genre, an artist, a title, a filename of the multimedia data, and a message informing that the meta information does not exist.
